(19) United States
(12) Patent Application Publication
(10) Pub. No.: US 2020/0066116 A1
(43) Pub. Date: Feb. 27, 2020

(54) INFORMATION PROCESSING APPARATUS, INFORMATION PROCESSING METHOD, AND PROGRAM

(71) Applicant: SONY CORPORATION, TOKYO (JP)

(72) Inventors: MARI SAITO, KANAGAWA (JP); KENJI SUGIHARA, KANAGAWA (JP)

(21) Appl. No.: 16/489,103

(22) PCT Filed: Feb. 16, 2018
(86) PCT No.: PCT/JP2018/005472

§ 371 Date: Aug. 27, 2019

(30) Foreign Application Priority Data
Mar. 28, 2017 (JP) 2017-063001

(51) Int. Cl. G08B 5/22; G08B 23/00; G05B 15/02; B25J 13/06

(52) U.S. Cl. CPC G08B 5/22; B25J 13/06; G05B 15/02; G08B 23/00

(57) ABSTRACT

It is desirable to provide a technology capable of performing control such that the user is notified in a manner more desirable for the user in a case where an event occurs. There is provided an information processing apparatus including: an acquisition unit that acquires detected data that includes at least one of an importance level or an urgency level of an event; and a notification control unit that controls a notification object that makes a notification in various ways depending on content of the detected data such that the notification object notifies a user of predetermined notification content, in which the notification control unit controls the notification object to be or not to be positioned in a central field of view or an effective field of view of the user on the basis of the detected data.

### TECHNICAL FIELD

The present disclosure relates to an information processing apparatus, an information processing method, and a program.

### BACKGROUND ART

In recent years, there are known technologies related to an agent that controls execution of processing on behalf of a user. For example, there is disclosed a technology related to an agent that performs control such that a user is notified using a line of sight. As an example, there is a disclosed technology related to an agent that performs control such that a user is notified by using a line of sight more naturally (for example, refer to Patent Document 1). A timing at which the user is notified using a line of sight is assumed to be a case where a certain event occurs, or the like.

### CITATION LIST

### Patent Document

### Patent Document 1: Japanese Patent Application Laid-Open No. 2013-006232

### SUMMARY OF THE INVENTION

### Problems to be Solved by the Invention

However, it is assumed that a preferred position for the user at which notification is made to the user in a case where an event occurs would depend on the type of the event. Therefore, it is desirable to provide a technology capable of performing control such that the user is notified in a manner more desirable for the user in a case where an event occurs.

### Solutions to Problems

According to the present disclosure, there is provided an information processing apparatus including: an acquisition unit that acquires detected data that includes at least one of an importance level or an urgency level of an event; and a notification control unit that controls a notification object that makes a notification in various ways depending on content of the detected data such that the notification object notifies a user of predetermined notification content, in which the notification control unit controls the notification object to be or not to be positioned in a central field of view or an effective field of view of the user on the basis of the detected data.

According to the present disclosure, there is provided an information processing method including: acquiring detected data that includes at least one of an importance level or an urgency level of an event; and controlling a notification object that makes a notification in various ways depending on content of the detected data such that the notification object notifies a user of predetermined notification content, and the method further including controlling, by a processor, the notification object to be or not to be positioned in a central field of view or an effective field of view of the user on the basis of the detected data.

According to the present disclosure, there is provided a program that enables a computer to function as an information processing apparatus including: an acquisition unit that acquires detected data that includes at least one of an importance level or an urgency level of an event; and a notification control unit that controls a notification object that makes a notification in various ways depending on content of the detected data such that the notification object notifies a user of predetermined notification content, in which the notification control unit controls the notification object to be or not to be positioned in a central field of view or an effective field of view of the user on the basis of the detected data.

### Effects of the Invention

As described above, according to the present disclosure, there is provided a technology capable of performing control such that the user is notified in a manner more desirable for the user in a case where an event occurs. Note that the effect of the present disclosure is not limited to the above-described effect, and one of the effects described in this specification or other effects that can be assumed from this specification may be provided together with or instead of the above-described effect.

### BRIEF DESCRIPTION OF DRAWINGS

FIG. 1 is a view illustrating a configuration example of an information processing system according to an embodiment of the present disclosure.

FIG. 2 is a diagram illustrating a functional configuration example of an agent.

FIG. 3 is a diagram illustrating a detailed configuration example of a control unit.

FIG. 4 is a view illustrating an example of each of a central field of view, an effective field of view, and a peripheral field of view.

FIG. 5 is a diagram illustrating an example of association information in which event types, sound features, importance levels, and urgency levels are associated with each other.

FIG. 6 is a view illustrating an example in which the state of a device “kitchen” has turned to a state “burned”.

FIG. 7 is a view illustrating an example in which the state of a device “washing machine” has turned to a state “washing finished”.

FIG. 8 is a view illustrating an example in which the state of the device “washing machine” has turned to a state “washing finished”.

FIG. 9 is a view illustrating an example in which the state of a device “ringing bell” has turned to a state “ringing”.

FIG. 10 is a view illustrating an example in which the state of the device “ringing bell” has turned to a state “ringing”.

FIG. 11 is a view illustrating an example in which the state of a device “mobile terminal” has turned to a state “mail reception”.

FIG. 12 is a diagram summarizing the correspondence between the importance level and the urgency level, and the position of the notification object.

FIG. 13 is a flowchart illustrating an operation example of an information processing system.

FIG. 14 is a diagram summarizing another correspondence between the importance level and the urgency level, and the position of the notification object.

FIG. 15 is a diagram summarizing another correspondence between the importance level and the urgency level, and the position of the notification object.

FIG. 16 is a block diagram illustrating a hardware configuration example of an information processing apparatus.

### MODE FOR CARRYING OUT THE INVENTION

Preferred embodiments of the present disclosure will be described in detail below with reference to the accompanying drawings. Note that same reference numerals are assigned to constituent elements having substantially the same functional configuration, and redundant description is omitted in the present specification and the drawings.

Furthermore, in this specification and the drawings, a plurality of constituents having substantially the same or similar function may be distinguished by giving the same reference numerals followed by different numbers in some cases. However, in a case where there is no need to particularly distinguish each of a plurality of constituents having substantially the same or similar functional configuration, the same reference numerals alone will be attached. Furthermore, similar constituents of different embodiments will be distinguished by attaching different alphabets after the same reference numerals in some cases. However, in a case where there is no need to particularly distinguish each of similar constituents, the same reference numerals alone will be attached.

Note that the description will be given in the following order.

0. Overview

1. Details of the embodiment

1.1. System configuration example

1.2. Functional configuration example of agent

1.3. Functional details of information processing system

1.3.1. Example of first event

1.3.2. Example of second event

1.3.3. Example of third event

1.3.4. Example of fourth event

1.3.5. Correspondence between event and location of notification object

1.3.6. Various modifications

1.3.7. Operation example

1.3.8. Another example of position control of notification object

2. Hardware configuration example

3. Conclusion

### 0. OVERVIEW

First, an outline of an embodiment of the present disclosure will be described. In recent years, there are known technologies related to an agent that controls execution of processing on behalf of a user. For example, there is disclosed a technology related to an agent that performs control such that a user is notified using a line of sight to a user. As an example, a technology related to an agent that performs control such that a user is notified using a line of sight to a user more naturally is disclosed. A timing at which the notification is made to the user by line of sight is assumed to be a case where a certain event occurs, or the like.

However, it is assumed that a preferred position for the user at which notification is made to the user in a case where an event occurs would depends on the type of the event. For example, it is assumed that a preferred position for the user at which notification is made to the user in a case where an event occurs would depends on the importance level or the urgency level. Therefore, the present specification will mainly describe a technology capable of performing control such that the user is notified in a manner more desirable for the user in a case where an event occurs.

Outline of the embodiment of the present disclosure has been described above.

### 1. DETAILS OF EMBODIMENTS

First, details of the embodiment of the present disclosure will be described.

### 1.1. System Configuration Example

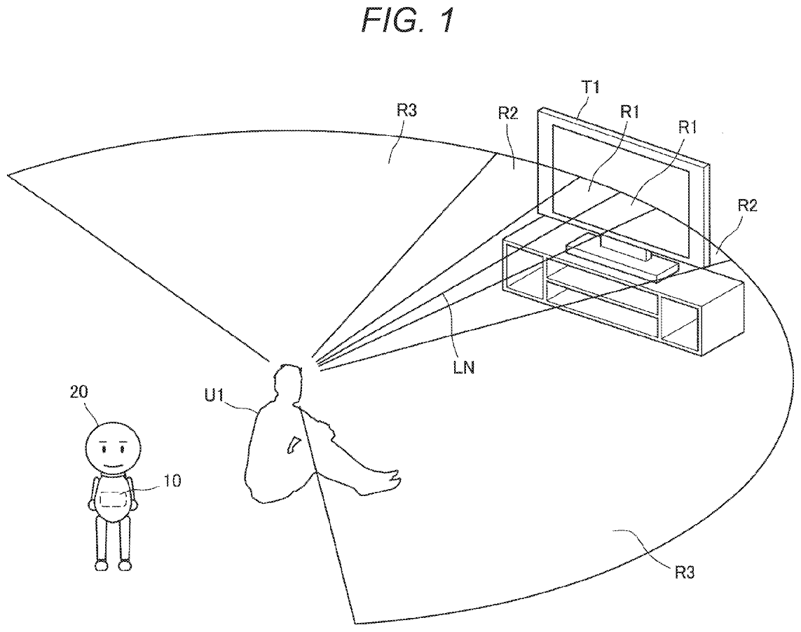

First, a configuration example of an information processing system according to an embodiment of the present disclosure will be described with reference to the drawings. FIG. 1 is a view illustrating a configuration example of an information processing system according to the embodiment of the present disclosure. As illustrated in FIG. 1, an information processing system according to the embodiment of the present disclosure includes an information processing apparatus 10. Here, in the present embodiment, a case where the information processing apparatus 10 is an agent that controls execution of processing on behalf of a user U1 will be mainly described. Therefore, in the following description, the information processing apparatus 10 is mainly referred to as an “agent 10”. However, the information processing apparatus 10 is not limited to the agent.

Referring to FIG. 1, the user U1 applies a line of sight LN to a screen of a television device T1. In this manner, the present embodiment mainly assumes that the user U1 is watching the screen of the television device T1. However, the user U1 may point the line of sight LN to an object different from the television device T1. Furthermore, referring to FIG. 1, a central field of view R1, an effective field of view R2 and a peripheral field of view R3 are illustrated with reference to the line of sight LN of the user U1. The central field of view R1, the effective field of view R2 and the peripheral field of view R3 will be described in detail later.

The present embodiment mainly assumes that a certain event occurs while the user U1 is watching the screen of the television device T1. Specific examples of events will be described in detail later. In the present embodiment, in a case where an event occurs, the notification object 20 notifies the user U1 of predetermined notification content. An example of the notification content will also be described in detail later.

Furthermore, the present embodiment mainly assumes that the notification object 20 includes a real object located in a real space. However, the notification object 20 may include a virtual object located in a virtual space. For example, in a case where the notification object 20 includes a virtual object, the notification object 20 may be an object displayed by a display or an object displayed by a projector.

Furthermore, in the present embodiment, it is mainly assumed that the agent 10 and the notification object 20 are integrated. However, the agent 10 and the notification object 20 do not have to be integrated. For example, the agent 10 and the notification object 20 may exist separately from each other. The notification object 20 notifies the user U1 from any of the central field of view R1, the effective field of view R2 and the peripheral field of view R3 in a case where an event occurs.

The configuration example of the information processing system according to the present embodiment has been described above.

### 1.2. Functional Configuration Example of Agent

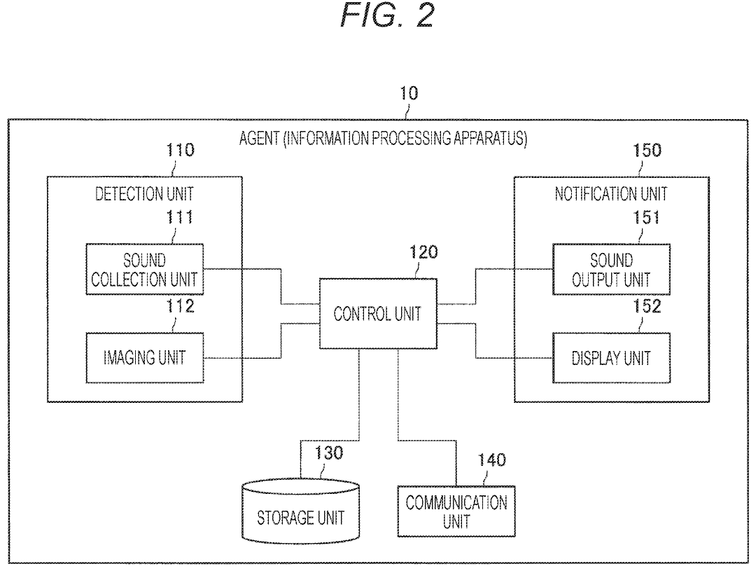

Subsequently, a functional configuration example of the agent 10 will be described. FIG. 2 is a diagram illustrating a functional configuration example of the agent 10. As illustrated in FIG. 2, the agent 10 includes a detection unit 110, a control unit 120, a storage unit 130, a communication unit 140, and a notification unit 150. The detection unit 110 has a function of detecting sound data and an image, and includes a sound collection unit 111 and an imaging unit 112. Furthermore, the notification unit 150 has a function of notifying the user U1, and includes a sound output unit 151 and a display unit 152.

The sound collection unit 111 has a function of acquiring sound data by sound collection. For example, the sound collection unit 111 includes a microphone, and performs sound collection by the microphone. The number of sound collection units 111 is not particularly limited as long as it is one or more. In addition, the position of the sound collection unit 111 is not specifically limited. For example, the sound collection unit 111 may be integrated with the notification object 20 or may exist separately from the notification object 20.

The imaging unit 112 has a function of acquiring an image by imaging. For example, the imaging unit 112 includes a camera (including an image sensor), and acquires an image captured by the camera. The type of camera is not limited. For example, the camera may be a camera that acquires an image from which the line of sight LN of the user U1 may be detected. The number of imaging units 112 is not particularly limited as long as it is one or more. In addition, the position of the imaging unit 112 is not specifically limited. For example, the imaging unit 112 may be integrated with the notification object 20 or may exist separately from the notification object 20.

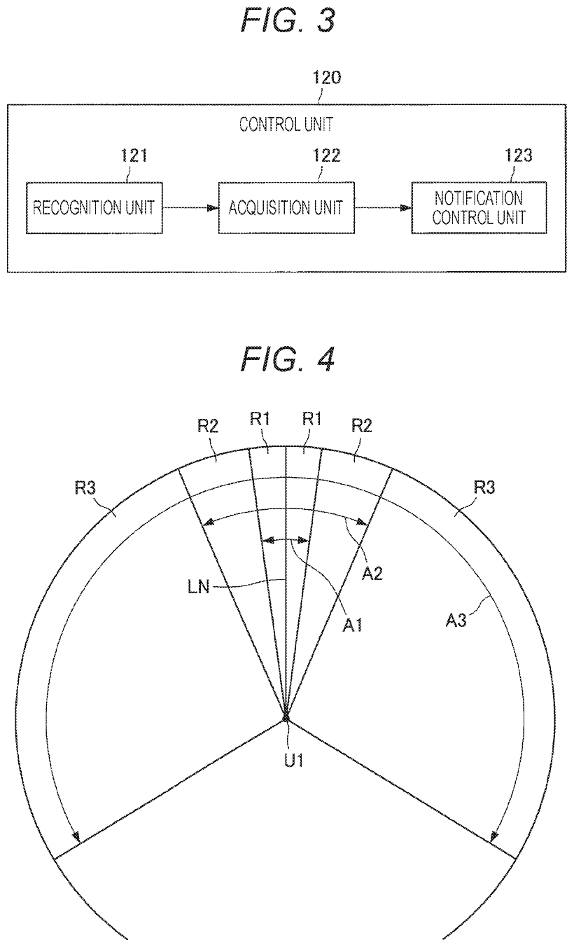

The control unit 120 controls each of units of the agent 10. FIG. 3 is a diagram illustrating an example of a detailed configuration example of the control unit 120. As illustrated in FIG. 3, the control unit 120 includes a recognition unit 121, an acquisition unit 122, and a notification control unit 123. Details of each of these functional blocks will be described later. Note that the control unit 120 may include one or more central processing units (CPUs) and the like, for example. In a case where the control unit 120 includes a processing unit such as a CPU, the processing unit may include an electronic circuit.

Referring again to FIG. 2, the description will be continued. The communication unit 140 includes a communication circuit, and has functions of acquiring data from a server device (not illustrated) connected to the communication network via a communication network and supplying the data to the server device (not illustrated). For example, the communication unit 140 includes a communication interface. Note that the number of server devices (not illustrated) connected to the communication network may be one or more.

The storage unit 130 is a recording medium that includes a memory and that has a function of storing a program executed by the control unit 120 or storing data necessary for execution of the program. Furthermore, the storage unit 130 temporarily stores data for the calculation by the control unit 120. The storage unit 130 includes a magnetic storage device, a semiconductor storage device, an optical storage device, a magneto-optical storage device, or the like.

The sound output unit 151 has a function of outputting a sound. For example, the sound output unit 151 includes a speaker, and outputs a sound by the speaker. The number of sound output units 151 is not particularly limited as long as it is one or more. In addition, the position of the sound output unit 151 is not specifically limited. However, in the present embodiment, since it is desirable to allow the user U1 to hear the sound output from the notification object 20, it is desirable that the sound source of the sound output unit 151 be integrated with the notification object 20.

The display unit 152 has a function of performing display that can be viewed by the user U1. The present embodiment mainly assumes that the display unit 152 includes a drive device that generates a facial expression of the notification object 20. However, the display unit 152 may be any device as long as it can perform display that can be viewed by the user, and may be a display such as a liquid crystal display and an organic electro-luminescence (EL) display, or a projector.

The functional configuration example of the agent 10 according to the present embodiment has been described above.

### 1.3. Functional Details of Information Processing System

Subsequently, function details of the information processing system according to the present embodiment will be described. As described above, in a case where an event occurs, the notification object 20 notifies the user U1 from any of the central field of view R1, the effective field of view R2 and the peripheral field of view R3. Here, examples of each of the central field of view R1, the effective field of view R2 and the peripheral field of view R3 will be described in detail with reference to FIG. 4.

FIG. 4 is a view illustrating an example of each of the central field of view R1, the effective field of view R2, and the peripheral field of view R3. Here, an example of each of field of views in the horizontal direction passing through the position of the user U1 will be described. Referring to FIG. 4, the user U1 and the line of sight LN of the user U1 are illustrated. As illustrated in FIG. 4, the central field of view R1 may be a region including the line of sight LN. For example, the central field of view R1 may be a region sandwiched between a straight line passing through the position of the user U1 and a straight line having an angle with the line of sight LN being an angle (A1/2). FIG. 4 illustrates the angle A1. The specific size of the angle A1 is not limited, and the angle A1 may be any angle in a range of 1 to 2 degrees, for example.

Furthermore, as illustrated in FIG. 4, the effective field of view R2 may be a region outside the central field of view R1 with respect to the line of sight LN. For example, the effective field of view R2 may be a region obtained by excluding the central field of view R1 from a region sandwiched between straight lines passing through the position of the user U1 and forming an angle (A2/2) with the line of sight LN. The angle A2 is illustrated in FIG. 4. The specific size of the angle A2 is not limited, and the angle A2 may be any angle in a range of 4 to 20 degrees, for example.

Furthermore, as illustrated in FIG. 4, the peripheral field of view R3 may be a region outside the effective field of view R2 with reference to the line of sight LN. For example, the peripheral field of view R3 may be a region obtained by excluding the central field of view R1 and the effective field of view R2 from a region sandwiched between straight lines passing through the position of the user U1 and forming an angle (A3/2) with the line of sight LN. The angle A3 is illustrated in FIG. 4. The specific size of the angle A3 is not limited, and it may be, for example, about 200 degrees.

Note that an example of each of field of views in the horizontal direction passing through the position of the user U1 has been described here. However, each of field of views in other directions (for example, vertical direction) may be defined in a similar manner. In that case, the angles corresponding to the above-described angles A1 to A3 may vary depending on the direction. For example, since the field of view in the horizontal direction tends to be wider than the field of view in the vertical direction, the angles corresponding to the above-described angles A1 to A3 in the vertical direction may be smaller than the above-described angles A1 to A3 in the horizontal direction.

Furthermore, the present embodiment mainly assumes that one user is present. However, it is also assumed that a plurality of users is present. In such a case, the above-described angles A1 to A3 may be the same or different for the plurality of users. Alternatively, the angles A1 to A3 described above may be different for states of the user. For example, in a case where the user U1 is watching the screen of the television device T1, the angles A1 to A3 may be narrower than in a case where the user U1 is reading a magazine.

In the above, examples of each of the central field of view R1, the effective field of view R2 and the peripheral field of view R3 have been described. In the present embodiment, the notification object 20 is controlled to be or not to be positioned in one of the central field of view R1 or the effective field of view R2 of the user U1 in a case where an event occurs. More specifically, the acquisition unit 122 acquires detected data including at least one of the importance level or the urgency level of the event. Subsequently, the notification control unit 123 controls the notification object 20 such that the notification object 20 notifies the user U1 of notification content that varies depending on the content of the detected data.

At this time, the notification control unit 123 controls the notification object 20 to be or not to be positioned in the central field of view R1 or the effective field of view R2 of the user U1 on the basis of the detected data. According to such control, it is possible to control the notification object 20 such that notification is to be made by the notification object 20 to the user U1 in a manner more desirable for the user U1 in a case where an event occurs.

In the following, a case where detected data includes both the importance level and the urgency level will mainly be described. However, the detected data may include one of the importance level or the urgency level. Furthermore, the present embodiment will mainly describe an example in which a case that a state of device turns to a predetermined state is acquired an event. However, the event acquired by the acquisition unit 122 is not limited to the case where the state of the device has turned to a predetermined state. For example, the event acquired by the acquisition unit 122 may be a case where an article other than the device (for example, a person or the like) has turned to a predetermined state. For example, the event acquired by the acquisition unit 122 may be a case where a person has turned to a predetermined state (for example, a state in which an infant starts crying, or the like).

Here, the event may be acquired in any manner. As an example, the acquisition unit 122 may acquire detected data from the information received from the device. However, it is also assumed that information including detected data is not directly transmitted from the device. Hereinafter, a case where the recognition unit 121 acquires an analysis result of the sound data by analyzing the sound data collected by the sound collection unit 111 will be mainly described. In such a case, in a case where the analysis result of the sound data matches or is similar to registered information registered beforehand, the acquisition unit 122 acquires detected data associated with the registered information.

The similarity range between the analysis result of the sound data and the registered information is not particularly limited. For example, the similarity range between the analysis result of the sound data and the registered information may be set beforehand. For example, in a case where the registered information is stored beforehand by the storage unit 130, the acquisition unit 122 may acquire the registered information from the storage unit 130. Hereinafter, a case where the feature of a sound is stored beforehand by the storage unit 130 will be mainly described as an example of registered information.

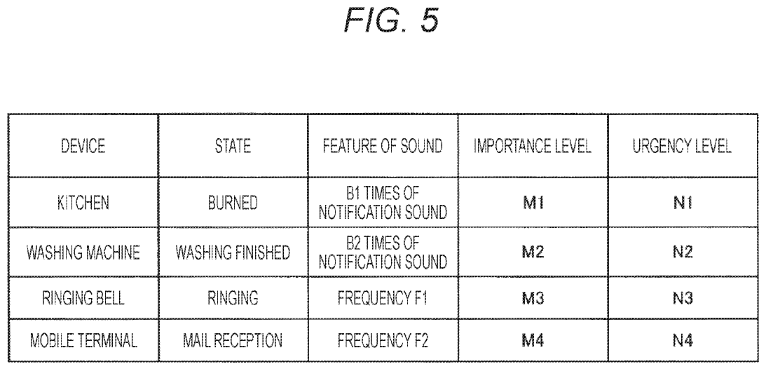

FIG. 5 is a diagram illustrating an example of association information in which event types, sound features, importance levels, and urgency levels are associated with each other. As illustrated in FIG. 5, the type of event may include the device and the state of the device. Furthermore, as illustrated in FIG. 5, the feature of the sound may be the number of times the device emits a notification sound, the frequency of the sound emitted by the device, or the like. Alternatively, the feature of the sound may be a coming direction of the sound emitted by the device, for example. Furthermore, each of the importance level and the urgency level may be represented by numerical values. Such association information may be stored beforehand by the storage unit 130.

### 1.3.1. Example of First Event

First, as an example of the first event, an example in which the state of the device “kitchen” has turned to a state “burned” will be described. Note that the following description will be given assuming the event that the state of the device “kitchen” has turned to the state “burned” has the importance level M1 higher than a first threshold and the urgency level N1 is higher than a second threshold. However, the importance level and urgency level of the event that the state of the device “kitchen” has turned to the state “burned” are not limited to such an example.

Furthermore, as described above, simply one of the importance level and the urgency level may be acquired by the acquisition unit 122. That is, in the following description, the condition that the importance level M1 is higher than the first threshold and the urgency level N1 is higher than the second threshold may be replaced with a simple condition that the importance level M1 is higher than the first threshold. Alternatively, in the following description, the condition that the importance level M1 is higher than the first threshold and the urgency level N1 is higher than the second threshold may be replaced with by a simple condition that the urgency level N1 is higher than the second threshold.

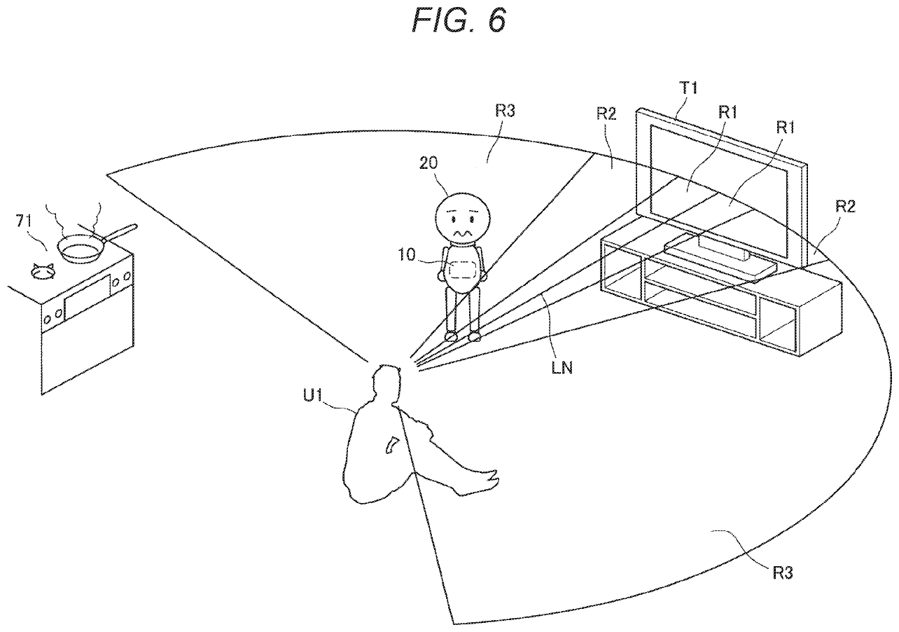

FIG. 6 is a view illustrating an example in which the state of device “kitchen” has turned to a state “burned”. Referring to FIG. 6, the user U1 is watching the screen of the television device T1. However, the food on the pan is being burned in a kitchen 71. At this time, B1 times (where B1 is an integer of 1 or more) of notification sounds for notifying the state of “burned” are output from the kitchen 71. Subsequently, the sound collection unit 111 collects sound data including the notification sound.

The recognition unit 121 analyzes the sound data collected by the sound collection unit 111 and acquires an analysis result. Here, it is assumed that the recognition unit 121 acquires “B1 times of notification sounds” being the number of times of the notification sounds as an analysis result of the sound data. In such a case, the acquisition unit 122 acquires “B1 times of notification sound” being the analysis result of the sound data, and determines whether or not “B1 times of notification sound” being the analysis result of the sound data matches or similar to the feature (FIG. 5) of the sound registered beforehand.

Here, the acquisition unit 122 determines that “B1 times of notification sound” being the analysis result of the sound data matches “B1 times of notification sound” being the feature of the sound registered beforehand, and acquires the importance level M1 and the urgency level N1 associated with “B1 times of notification sound” being the feature of the sound registered beforehand. The notification control unit 123 compares the importance level M1 with the first threshold, and compares the urgency level N1 with the second threshold. Here, as described above, the notification control unit 123 determines that the importance level M1 is higher than the first threshold and the urgency level N1 is higher than the second threshold.

In a case where the importance level M1 is higher than the first threshold and the urgency level N1 is higher than the second threshold, it is considered that immediately moving the notification object 20 to a position clearly visible by the user U1 and notifying the user U1 of notification content from the notification object 20 would be desirable for the user U1. Therefore, in a case where the importance level M1 is higher than the first threshold and the urgency level N1 is higher than the second threshold, the notification control unit 123 controls such that the notification object 20 is positioned in one of the central field of view R1 or the effective field of view R2 of the user U1.

Note that one of the central field of view R1 or the effective field of view R2 is recognized by the recognition unit 121 as described with reference to FIG. 4 with respect to the line of sight LN of the user U1. The line of sight LN of the user U1 may be recognized on the basis of the image captured by the imaging unit 112. For example, in a case where an eye of the user U1 is imaged by the imaging unit 112, the recognition unit 121 may recognize the line of sight LN from the eye captured in the image. Alternatively, in a case where the imaging unit 112 captures an image of the face of the user U1, the recognition unit 121 may recognize the direction of the face captured in the image, as the line of sight LN.

Referring to FIG. 6, there is an illustrated example in which the notification control unit 123 moves the notification object 20 to the central field of view R1. Note that in a case where the notification object 20 is a real object, the notification control unit 123 only has to control the motor of the notification object 20 to move the notification object 20. In contrast, in a case where the notification object 20 is a virtual object, the notification control unit 123 only has to control the display or the projector to move the notification object 20.

Furthermore, the notification control unit 123 controls the notification unit 150 to notify the user U1 of the notification content according to the importance level M1 and the urgency level N1. The notification start timing of the notification content is not limited. For example, notification of the notification content may be started before the start of movement of the notification object 20, or may be started during the movement of the notification object 20, or may be started after the end of movement of the notification object 20.

Here, the notification content of which the user U1 is notified is not particularly limited. Such notification content may include the state of the notification object 20, or may include the motion of the notification object 20, or may include a sound emitted by the notification object 20. Alternatively, the notification content may include any two or more or all of the state of the notification object 20, the motion of the notification object 20, and the sound emitted by the notification object 20.

The state of the notification object 20 may include the facial expression of the notification object 20. FIG. 6 illustrates an example in which the notification control unit 123 turns the facial expression of the notification object 20 into a surprising facial expression and a serious facial expression. For example, “surprising facial expression and serious facial expression” may be replaced with “frightened facial expression” or “panicked facial expression”. Furthermore, control of the facial expression may be performed by control of at least one of the shape of one or more parts, orientation, or position of the face of the notification object 20.

Furthermore, one or more parts of the face controlled by the notification control unit 123 are not particularly limited. For example, one or more parts of the face controlled by the notification control unit 123 may include at least one of eyes, eyebrows, mouth, nose and cheeks. In the example illustrated in FIG. 6, the shape of the mouth of the notification object 20 is changed to a distorted shape, and the directions of eyebrows are changed to be lowered from the center toward the end of the face, so as to control the facial expression.

Furthermore, the state of the notification object 20 may include a distance between the notification object 20 and the user U1. For example, the notification control unit 123 may control the position of the notification object 20 such that the higher the importance level of the generated event, the shorter the distance between the notification object 20 and the user U1. Alternatively, the notification control unit 123 may control the position of the notification object 20 such that the higher the urgency level of the generated event, the shorter the distance between the notification object 20 and the user U1.

Furthermore, the motion of the notification object 20 may include the motion of part or all of the notification object 20. For example, the motion of the notification object 20 may be the motion of gazing at in the direction of the kitchen 71, a motion of tilting the neck, or the motion of nodding. Alternatively, the motion of the notification object 20 may be a motion of moving around the user U1 or a motion of pulling the user U1.

Alternatively, the motion of the notification object 20 may include the frequency at which the notification object 20 gazes at the user U1. For example, the notification control unit 123 may control the motion of the notification object 20 such that the higher the importance level of the generated event, the higher the frequency at which the notification object 20 gazes at the user U1. Alternatively, the notification control unit 123 may control the motion of the notification object 20 such that the higher the urgency level of the generated event, the higher the frequency at which the notification object 20 gazes at the user U1.

Alternatively, the motion of the notification object 20 may include the time during which the notification object 20 is gazing at the user U1. For example, the notification control unit 123 may control the motion of the notification object 20 such that the higher the importance level of the generated event, the longer the time during which the notification object 20 is gazing at the user U1. Alternatively, the notification control unit 123 may control the motion of the notification object 20 such that the higher the urgency level of the generated event, the longer the time during which the notification object 20 is gazing at the user U1.

Furthermore, the sound emitted by the notification object 20 is not particularly limited. For example, the sound emitted by the notification object 20 may be emitted by reading out text that can be interpreted by the user U1. For example, the text that can be interpreted by the user U1 may be a language such as “warning”, but is not particularly limited. Alternatively, the sound emitted by the notification object 20 may be a simple notification sound or the like.

### 1.3.2. Example of Second Event

Subsequently, an example in a case where the state of the device “washing machine” turns to the state “washing finished” will be described as an example of the second event. Note that the following description will be given assuming the event that the state of the device “washing machine” has turned to the state “washing finished” has the importance level M2 higher than the first threshold and the urgency level N2 lower than the second threshold. However, the importance level and urgency level of the event that the state of the device “washing machine” has turned to the state “washing finished” is not limited to such an example.

Furthermore, as described above, simply one of the importance level and the urgency level may be acquired by the acquisition unit 122. In other words, in the following description, the condition that the importance level M2 is higher than the first threshold and the urgency level N2 is lower than the second threshold may be replaced with a simple condition that the importance level M2 is higher than the first threshold. Alternatively, in the following description, the condition that the importance level M2 is higher than the first threshold and the urgency level N2 is lower than the second threshold may be replaced with a simple condition that the urgency level N2 is lower than the second threshold.

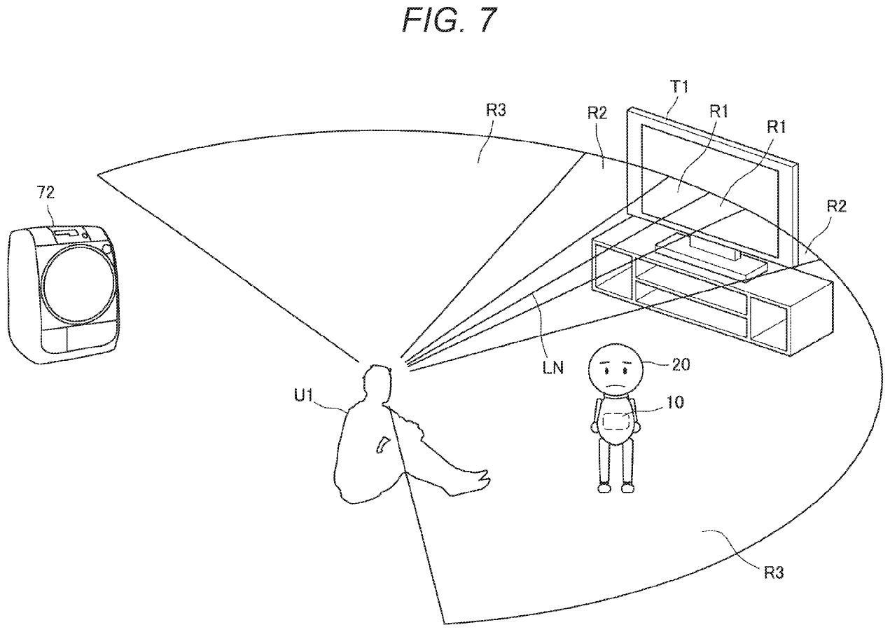

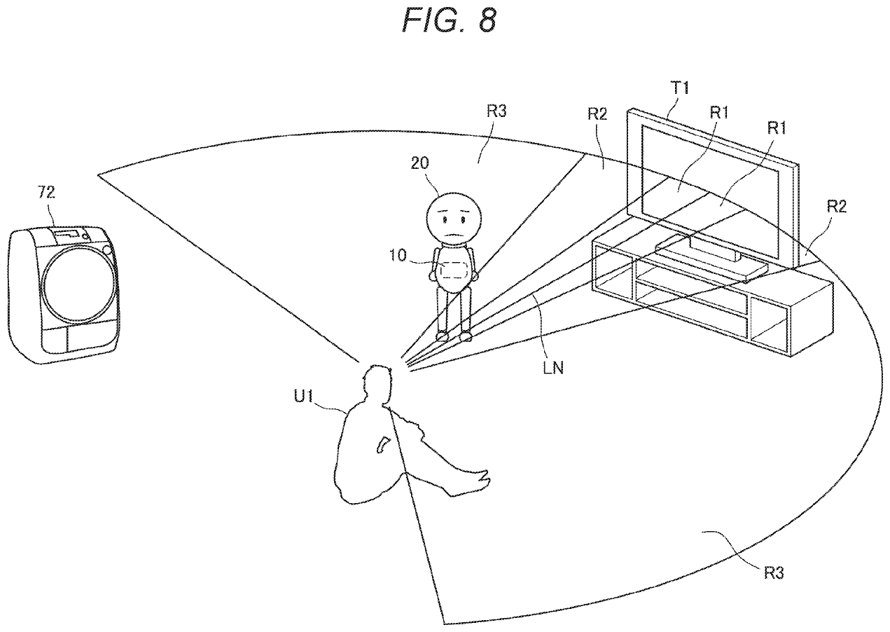

FIGS. 7 and 8 are views illustrating an example in which a state of device “washing machine” has turned to a state “washing finished”. Referring to FIG. 7, the user U1 is watching the screen of the television device T1. However, the washing is finished at the washing machine 72. At this time, B2 times (where B2 is an integer of 1 or more) of notification sounds for notifying the state “washing finished” are output from the washing machine 72. Subsequently, the sound collection unit 111 collects sound data including the notification sound.

The recognition unit 121 analyzes the sound data collected by the sound collection unit 111 and acquires an analysis result. Here is an assumable case where the recognition unit 121 acquires “B2 times of notification sound” being the number of times of the notification sounds as an analysis result of the sound data. In such a case, the acquisition unit 122 acquires “B2 times of notification sound” being the analysis result of the sound data, and determines whether or not “B2 times of notification sound” being the analysis result of the sound data matches or similar to the feature (FIG. 5) of the sound registered beforehand.

Here, the acquisition unit 122 determines that “B2 times of notification sound” being the analysis result of the sound data matches “B2 times of notification sound” being the feature of the sound registered beforehand, and acquires the importance level M2 and the urgency level N2 associated with “B2 times of notification sound” being the feature of the sound registered beforehand. The notification control unit 123 compares the importance level M2 with the first threshold, and compares the urgency level N2 with the second threshold. Here, as described above, the notification control unit 123 determines that the importance level M2 is higher than the first threshold and the urgency level N2 is lower than the second threshold.

In a case where the importance level M2 is higher than the first threshold and the urgency level N2 is lower than the second threshold, and in a state where the state of the user U1 is a predetermined state (for example, a state in which the user U1 is not watching the washing machine 72, in a case where the user U1 is not nodding, etc.), it is considered desirable for the user U1 that the notification object 20 is to be moved to a position clearly visible by the user U1, and the notification object 20 notifies the user U1 of notification content. The fact the state of the user U1 has turned to the predetermined state can be recognized by the recognition unit 121 from the image captured by the imaging unit 112.

Therefore, as illustrated in FIG. 7, in a case where the importance level M2 is higher than the first threshold and the urgency level N2 is lower than the second threshold, it is preferable that the notification control unit 123 first positions the notification object 20 in the peripheral field of view R3. Subsequently, the notification control unit 123 only has to control the notification object 20 to be or not to be positioned in one of the central field of view R1 or the effective field of view R2 of the user U1 in accordance with whether or not the state of the user U1 is a predetermined state. For example, in a case where the user U1 is in a predetermined state, the notification control unit 123 only has to move the notification object 20 to one of the central field of view R1 or the effective field of view R2 of the user U1, as illustrated in FIG. 8.

Note that one of the central field of view R1 or the effective field of view R2 is recognized by the recognition unit 121 similarly to the example of the first event. Furthermore, the peripheral field of view R3 is also recognized by the recognition unit 121 as described with reference to FIG. 4 with respect to the line of sight LN of the user U1. The movement of the notification object 20 may also be controlled by the notification control unit 123 similarly to the first event example.

Furthermore, the notification control unit 123 controls the notification unit 150 to notify the user U1 of the notification content according to the importance level M2 and the urgency level N2. The notification start timing of the notification content is not limited similarly to the case of the first event. For example, notification of the notification content may be started before the start of movement of the notification object 20 to the peripheral field of view R3, or may be started during the movement of the notification object 20 to the peripheral field of view R3, or may be started after the end of movement of the notification object 20 to the peripheral field of view R3.

Alternatively, the notification of the notification content may be started before the start of movement of the notification object 20 to one of the central field of view R1 or the effective field of view R2, or may be started during the movement of the notification object 20 to one of the central field of view R1 or the effective field of view R2, or may be started after the end of movement of the notification object 20 to one of the central field of view R1 or the effective field of view R2. In particular, there is a possibility that the user U1 cannot recognize the facial expression of the notification object 20 during the time when the notification object 20 is positioned in the peripheral field of view R3. Therefore, it is considered that control of the facial expression of the notification object 20 would not be too late even after the notification object 20 goes out of the peripheral field of view R3.

The notification content of which the user U1 is notified is not limited similarly to the case of the first event. However, it is preferable that the notification control unit 123 controls such that the notification content of which the user U1 is notified in the present example becomes different from the notification content of which the user U1 is notified in the example of the first event. Such notification content may include the state of the notification object 20, or may include the motion of the notification object 20, or may include a sound emitted by the notification object 20. Alternatively, the notification content may include any two or more or all of the state of the notification object 20, the motion of the notification object 20, and the sound emitted by the notification object 20.

The state of the notification object 20 may include the facial expression of the notification object 20. FIG. 7 illustrates an example in which the notification control unit 123 turns the facial expression of the notification object 20 into a serious facial expression. In the example illustrated in FIG. 7, the shape of the mouth of the notification object 20 is changed such that end portions of the mouth is lowered, and the directions of eyebrows are changed to be lowered from the center toward the end of the face, so as to control facial expression.

Furthermore, the state of the notification object 20 may include a distance between the notification object 20 and the user U1. Furthermore, the motion of the notification object 20 may include the motion of part or all of the notification object 20. In particular, as in the present example, in a case where the event is execution completion of some processing such as washing finished, the motion of the notification object 20 may be a motion of nodding. Alternatively, the motion of the notification object 20 may be a motion of nodding in a case where there is an inquiry from the user U1 about whether the processing execution has been completed, after watching the device.

Alternatively, the motion of the notification object 20 may include the frequency at which the notification object 20 gazes at the user U1. Alternatively, the motion of the notification object 20 may include the time during which the notification object 20 is gazing at the user U1.

Furthermore, the sound emitted by the notification object 20 is not particularly limited as similarly to the example of the first event. However, the sound emitted by the notification object 20 might interfere with the action of the user U1 during the time when the notification object 20 is positioned in the peripheral field of view R3. Therefore, the notification control unit 123 may control to suppress sound emission from the notification object 20. In contrast, the notification control unit 123 may control the notification object 20 such that a sound is emitted by the notification object 20 during the time when the notification object 20 is positioned in one of the central field of view R1 or the effective field of view R2.

### 1.3.3. Example of Third Event

Subsequently, an example in which the state of the device “ringing bell” has turned to the state “ringing” will be described as an example of the third event. Note that the following description will be given assuming the event that the state of the device “ringing bell” has turned to the state “ringing” has the importance level M3 being lower than the first threshold and the urgency level N2 being higher than the second threshold. However, the importance level and urgency level of the event that the state of the device “ringing bell” has turned to the state “ringing” is not limited to such an example.

Furthermore, as described above, simply one of the importance level and the urgency level may be acquired by the acquisition unit 122. That is, in the following description, the condition that the importance level M3 is lower than the first threshold and the urgency level N3 is higher than the second threshold may be replaced with a simple condition that the importance level M3 is lower than the first threshold. Alternatively, in the following description, the condition that the importance level M3 is lower than the first threshold and the urgency level N3 is higher than the second threshold may be replaced with a simple condition that the urgency level N3 is higher than the second threshold.

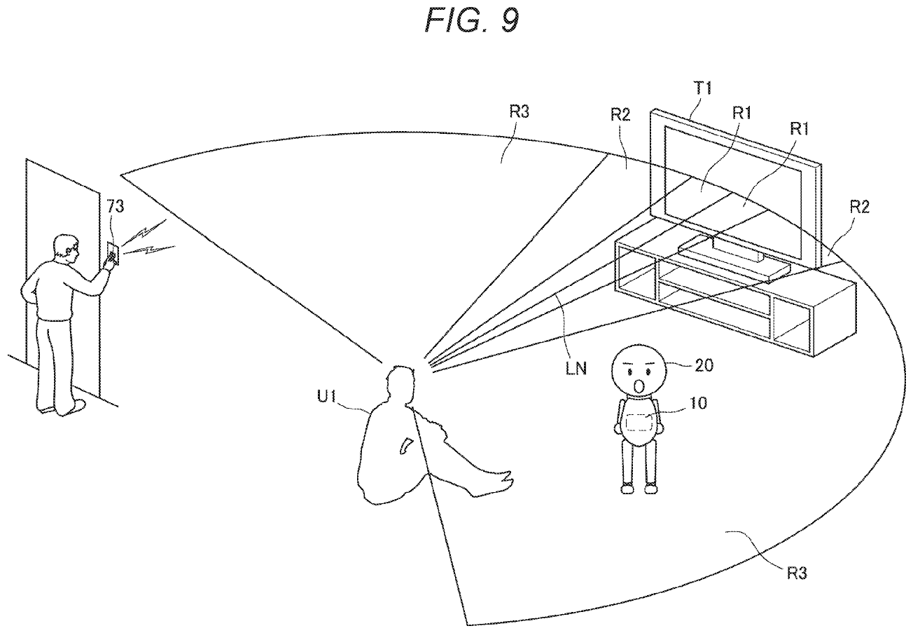

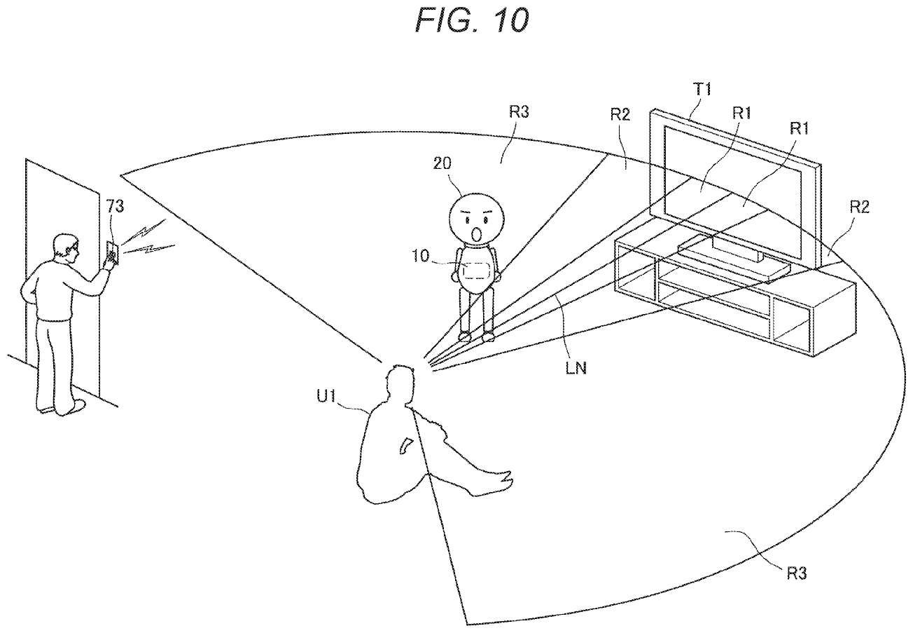

FIGS. 9 and 10 are views illustrating an example in which the state of the device “ringing bell” has turned to the state “ringing”. Referring to FIG. 9, the user U1 is watching the screen of the television device T1. However, a visitor to the user U1's home is pressing a ringing bell 73. At this time, a ringing tone of frequency F1 for notifying the state “ringing” is output from the ringing bell 73. Subsequently, the sound collection unit 111 collects sound data including the ringing tone.

The recognition unit 121 analyzes the sound data collected by the sound collection unit 111 and acquires an analysis result. Here is an assumable case where the recognition unit 121 acquires “frequency F1” being the frequency of the ringing tone as an analysis result of the sound data. In such a case, the acquisition unit 122 acquires “frequency F1” being an analysis result of the sound data, and determines whether or not the “frequency F1” being the analysis result of the sound data matches or similar to the feature (FIG. 5) of the sound registered beforehand.

Here, the acquisition unit 122 determines that “frequency F1” being the analysis result of the sound data matches “frequency F1” being the feature of the sound registered beforehand, and acquires the importance level M3 and the urgency level N3 associated with “frequency F1” being the feature of the sound registered beforehand. The notification control unit 123 compares the importance level M3 with the first threshold, and compares the urgency level N3 with the second threshold. Here, as described above, the notification control unit 123 determines that the importance level M3 is lower than the first threshold and the urgency level N3 is higher than the second threshold.

In a case where the importance level M3 is lower than the first threshold and the urgency level N3 is higher than the second threshold, and in a state where the user U1 is in a predetermined state (for example, a state in which the user U1 is not watching the washing machine 72, in a case where the user U1 is not nodding, or the like), it is considered desirable for the user U1 that the notification object 20 be moved to a position clearly visible by the user U1, and the notification object 20 notifies the user U1 of notification content. The fact the state of the user U1 has turned to the predetermined state can be recognized by the recognition unit 121 from the image captured by the imaging unit 112.

Therefore, as illustrated in FIG. 9, in a case where the importance level M3 is lower than the first threshold and the urgency level N3 is higher than the second threshold, it is preferable that the notification control unit 123 first positions the notification object 20 in the peripheral field of view R3. Subsequently, the notification control unit 123 only has to control the notification object 20 to be or not to be positioned in one of the central field of view R1 or the effective field of view R2 of the user U1 in accordance with whether or not the state of the user U1 is a predetermined state. For example, in a case where the user U1 is in a predetermined state, the notification control unit 123 only has to move the notification object 20 to one of the central field of view R1 or the effective field of view R2 of the user U1, as illustrated in FIG. 10.

Note that one of the central field of view R1 or the effective field of view R2 is recognized by the recognition unit 121 similarly to the example of the first event. Furthermore, the peripheral field of view R3 is also recognized by the recognition unit 121 as described with reference to FIG. 4 with respect to the line of sight LN of the user U1. The movement of the notification object 20 may also be controlled by the notification control unit 123 similarly to the first event example.

Furthermore, the notification control unit 123 controls the notification unit 150 to notify the user U1 of the notification content according to the importance level M3 and the urgency level N3. The notification start timing of the notification content is not limited similarly to the case of the first event. For example, notification of the notification content may be started before the start of movement of the notification object 20 to the peripheral field of view R3, or may be started during the movement of the notification object 20 to the peripheral field of view R3, or may be started after the end of movement of the notification object 20 to the peripheral field of view R3.

Alternatively, the notification of the notification content may be started before the start of movement of the notification object 20 to one of the central field of view R1 or the effective field of view R2, or may be started during the movement of the notification object 20 to one of the central field of view R1 or the effective field of view R2, or may be started after the end of movement of the notification object 20 to one of the central field of view R1 or the effective field of view R2. In particular, there is a possibility that the user U1 cannot recognize the facial expression of the notification object 20 during the time when the notification object 20 is positioned in the peripheral field of view R3. Therefore, it is considered that control of the facial expression of the notification object 20 would not be too late even after the notification object 20 goes out of the peripheral field of view R3.

The notification content of which the user U1 is notified is not limited similarly to the case of the first event. However, it is preferable that the notification control unit 123 controls such that the notification content of which the user U1 is notified in the present example becomes different from the notification content of which the user U1 is notified in each of the example of the first event and the example of the second event. Such notification content may include the state of the notification object 20, or may include the motion of the notification object 20, or may include a sound emitted by the notification object 20. Alternatively, the notification content may include any two or more or all of the state of the notification object 20, the motion of the notification object 20, and the sound emitted by the notification object 20.

The state of the notification object 20 may include the facial expression of the notification object 20. FIG. 9 illustrates an example in which the notification control unit 123 turns the facial expression of the notification object 20 into a surprising facial expression. In the example illustrated in FIG. 9, the shape of the mouth of the notification object 20 is changed to an open shape, and the directions of eyebrows are changed to be raised from the center toward the end of the face, so as to control the facial expression.

Furthermore, the state of the notification object 20 may include a distance between the notification object 20 and the user U1. Furthermore, the motion of the notification object 20 may include the motion of part or all of the notification object 20. In particular, in a case where an event is reception of a visit from someone, such as ringing by a ringing bell (or in a case where a question is received from someone, or the like) as in the present example, the motion of the notification object 20 may be the motion of tilting the head. Alternatively, the motion of the notification object 20 may be a motion of tilting the head in a case where, after gazing at the device, a question of whether a visit or question has been made from the user U1 or from someone. Alternatively, the motion of the notification object 20 may be a motion of moving around the user U1 or a motion of pulling the user U1.

Alternatively, the motion of the notification object 20 may include the frequency at which the notification object 20 gazes at the user U1. Alternatively, the motion of the notification object 20 may include the time during which the notification object 20 is gazing at the user U1.

Furthermore, the sound emitted by the notification object 20 is not particularly limited as similarly to the example of the first event. However, the sound emitted by the notification object 20 might interfere with the action of the user U1 during the time when the notification object 20 is positioned in the peripheral field of view R3. Therefore, the notification control unit 123 may control to suppress sound emission from the notification object 20. In contrast, the notification control unit 123 may control the notification object 20 such that a sound is emitted by the notification object 20 during the time when the notification object 20 is positioned in one of the central field of view R1 or the effective field of view R2.

### 1.3.4. Example of Fourth Event

Subsequently, an example of a case where the state of the device “mobile terminal” has turned to a state “mail reception” will be described as an example of a fourth event. Note that the following description will be given assuming the event that the state of the device “mobile terminal” has turned to the state “mail reception” has the importance level M4 lower than the first threshold and the urgency level N4 lower than the second threshold. However, the importance level and urgency level of the event that the state of the device “mobile terminal” has turned to the state “mail reception” is not limited to such an example.

Furthermore, as described above, simply one of the importance level and the urgency level may be acquired by the acquisition unit 122. That is, in the following description, the condition that the importance level M4 is lower than the first threshold and the urgency level N4 is lower than the second threshold may be replaced with a simple condition that the importance level M4 is lower than the first threshold. Alternatively, in the following description, the condition that the importance level M4 is lower than the first threshold and the urgency level N4 is higher than the second threshold may be replaced with a simple condition that the urgency level N4 is lower than the second threshold.

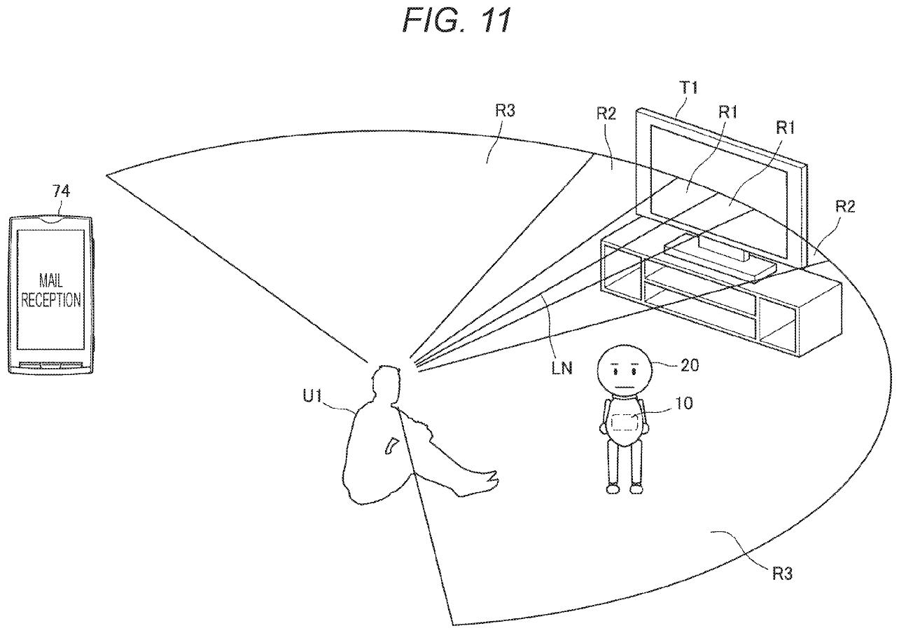

FIG. 11 is a view illustrating an example in which the state of a device “mobile terminal” has turned to the state “mail reception”. Referring to FIG. 11, the user U1 is watching the screen of the television device T1. However, the mobile terminal 74 is receiving a mail. At this time, a ringtone of frequency F2 for notifying the state “mail reception” is output from the mobile terminal 74. Subsequently, the sound collection unit 111 collects sound data including the ringtone.

The recognition unit 121 analyzes the sound data collected by the sound collection unit 111 and acquires an analysis result. Here is an assumable case where the recognition unit 121 acquires “frequency F2” being the frequency of the ringing tone as an analysis result of the sound data. In such a case, the acquisition unit 122 acquires “frequency F2” being an analysis result of the sound data, and determines whether or not the “frequency F2” being the analysis result of the sound data matches or similar to the feature (FIG. 5) of the sound registered beforehand.

Here, the acquisition unit 122 determines that “frequency F2” being the analysis result of the sound data and “frequency F2” being the feature of the sound registered beforehand match, and acquires the importance level M4 and the urgency level N4 associated with “frequency F2” being the feature of the sound registered beforehand. The notification control unit 123 compares the importance level M4 with the first threshold, and compares the urgency level N4 with the second threshold. Here, as described above, the notification control unit 123 determines that the importance level M4 is lower than the first threshold and the urgency level N4 is lower than the second threshold.

In a case where the importance level M4 is lower than the first threshold and the urgency level N4 is lower than the second threshold, it is considered that moving the notification object 20 to a position not clearly visible by the user U1 (for example, position faintly visible) and notifying notification content from the notification object 20 would be desirable for the user U1. Therefore, as illustrated in FIG. 11, in a case where the importance level M4 is lower than the first threshold and the urgency level N4 is lower than the second threshold, the notification control unit 123 controls the notification object 20 to be positioned in the peripheral field of view R3.

Note that the peripheral field of view R3 is recognized by the recognition unit 121 similarly to the second example of the event and the third example of the event. The movement of the notification object 20 may also be controlled by the notification control unit 123 similarly to the first event example.

Furthermore, the notification control unit 123 controls the notification unit 150 to notify the user U1 of the notification content according to the importance level M4 and the urgency level N4. The notification start timing of the notification content is not limited similarly to the case of the first event. For example, notification of the notification content may be started before the start of movement of the notification object 20 to the peripheral field of view R3, or may be started during the movement of the notification object 20 to the peripheral field of view R3, or may be started after the end of movement of the notification object 20 to the peripheral field of view R3.

Alternatively, the notification of the notification content may be started before the start of movement of the notification object 20 to one of the central field of view R1 or the effective field of view R2, or may be started during the movement of the notification object 20 to one of the central field of view R1 or the effective field of view R2, or may be started after the end of movement of the notification object 20 to one of the central field of view R1 or the effective field of view R2. However, there is a possibility that the user U1 cannot recognize the facial expression of the notification object 20 during the time when the notification object 20 is positioned in the peripheral field of view R3. Therefore, control of the facial expression of the notification object 20 would not have to be performed while the notification object 20 is present in the peripheral field of view R3.

The notification content of which the user U1 is notified is not limited similarly to the case of the first event. However, it is preferable that the notification control unit 123 controls such that the notification content of which the user U1 is notified in the present example becomes different from the notification content of which the user U1 is notified in each of the example of the first event, the example of the second event, and the example of the third event. Such notification content may include the state of the notification object 20, or may include the motion of the notification object 20, or may include a sound emitted by the notification object 20. Alternatively, the notification content may include any two or more or all of the state of the notification object 20, the motion of the notification object 20, and the sound emitted by the notification object 20.

The state of the notification object 20 may include the facial expression of the notification object 20. However, as described above, there is a possibility that the user U1 cannot recognize the facial expression of the notification object 20 during the time when the notification object 20 is positioned in the peripheral field of view R3. Therefore, the state of the notification object 20 does not have to include the facial expression of the notification object 20. FIG. 11 illustrates an example in which the notification control unit 123 does not change the facial expression of the notification object 20 from the normal expression illustrated in FIG. 1.

Furthermore, the state of the notification object 20 may include a distance between the notification object 20 and the user U1. Furthermore, the motion of the notification object 20 may include the motion of part or all of the notification object 20. Alternatively, the motion of the notification object 20 may include the frequency at which the notification object 20 gazes at the user U1. Alternatively, the motion of the notification object 20 may include the time during which the notification object 20 is gazing at the user U1.

Furthermore, the sound emitted by the notification object 20 is not particularly limited as similarly to the example of the first event. However, in the notification control unit 123, the sound emitted by the notification object 20 might interfere with the action of the user U1 during the time when the notification object 20 is positioned in the peripheral field of view R3. Therefore, the notification control unit 123 may suppress sound emission from the notification object 20 during the time when the notification object 20 is positioned in the peripheral field of view R3.

### 1.3.5. Correspondence Between Event and Location of Notification Object

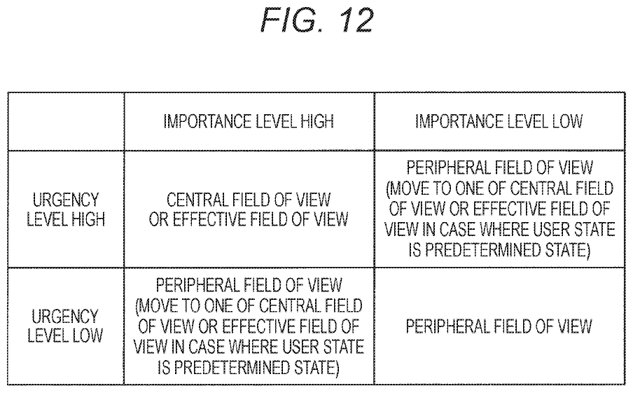

Hereinabove, examples of each of the first to fourth events have been described. FIG. 12 is a diagram summarizing the correspondence between the importance level and the urgency level and the position of the notification object 20. Note that in the example illustrated in FIG. 12, “high importance level” indicates that the importance level is higher than the first threshold, and “low importance level” indicates that the importance level is lower than the first threshold. Furthermore, in the example illustrated in FIG. 12, “high urgency level” indicates that the urgency level is higher than the second threshold, and “low urgency level” indicates that the urgency level is lower than the second threshold.

As illustrated in FIG. 12, in a case where the importance level of the event is higher than the first threshold and the urgency level of the event is higher than the second threshold, the notification control unit 123 controls that the notification object 20 such that the notification object 20 is positioned in either the central field of view R1 or the effective field of view R2.

In contrast, as illustrated in FIG. 12, in a case where the importance level of the event is higher than the first threshold and the urgency level of the event is lower than the second threshold, the notification control unit 123 controls that the notification object 20 such that the notification object 20 is positioned in the peripheral field of view R3. At this time, as illustrated in FIG. 12, in a case where the state of the user U1 is a predetermined state, the notification control unit 123 controls the notification object 20 so that the notification object 20 moves to the central field of view R1 or the effective field of view R2.

In contrast, as illustrated in FIG. 12, in a case where the importance level of the event is lower than the first threshold and the urgency level of the event is higher than the second threshold, the notification control unit 123 controls that the notification object 20 such that the notification object 20 is positioned in the peripheral field of view R3. At this time, as illustrated in FIG. 12, in a case where the state of the user U1 is a predetermined state, the notification control unit 123 controls the notification object 20 so that the notification object 20 moves to the central field of view R1 or the effective field of view R2.

In contrast, as illustrated in FIG. 12, in a case where the importance level of the event is lower than the first threshold and the urgency level of the event is lower than the second threshold, the notification control unit 123 controls that the notification object 20 such that the notification object 20 is positioned in the peripheral field of view R3.

### 1.3.6. Various Modifications

The example above has mainly described that, in a case where an event occurs, the notification object 20 notifies the user U1 of the notification content without particular conditions. However, it is allowable to have a case where the user U1 is not notified of the notification content. For example, in a case where the status of the user U1 is a predetermined status, the notification control unit 123 may control the notification object 20 such that the notification object 20 does not notify the user U1 of the notification content.

For example, it is assumed that the recognition unit 121 has recognized that the user U1 has already watched the device that has turned to a predetermined state. In such a case, the notification control unit 123 may control the notification object 20 such that that the notification object 20 would not notify the user U1 of the notification content. For example, the recognition unit 121 can recognize, from the image captured by the imaging unit 112, that the user U1 has watched the device that has turned to a predetermined state.

Furthermore, the example above has mainly described a case that the notification object 20 notifies the user U1 of the notification content simply once in a case where an event occurs. However, the user U1 may be notified of the notification content twice or more. For example, in a case where the event is a predetermined event (for example, an event that should not be left unattended, or the like), the notification control unit 123 preferably controls the notification object 20 to notify the user U1 of the notification content again at a stage where operation of the user is transited to next operation. For example, operation of the user U1 can be recognized by the recognition unit 121 from the image captured by the imaging unit 112.

### 1.3.7. Operation Example

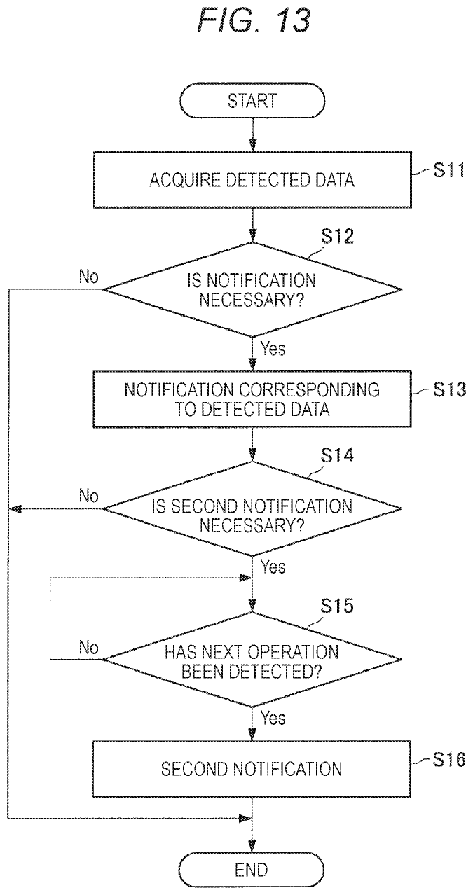

Subsequently, an operation example of the information processing system according to the present embodiment will be described. FIG. 13 is a flowchart illustrating an operation example of the information processing system according to the present embodiment. As illustrated in FIG. 13, the acquisition unit 122 acquires detected data including at least one of the importance level and the urgency level of an event (S11). Subsequently, the notification control unit 123 determines the necessity of notification to the user U1. For example, whether or not notification to the user U1 is necessary can be determined by whether or not the user U1 has already watched the device in which the event has occurred.

Subsequently, in a case where notification to the user U1 is not necessary (“No” in S12), the notification control unit 123 finishes the operation. In contrast, in a case where notification to the user U1 is necessary (“Yes” in S12), the notification control unit 123 controls the notification object 20 such that a notification corresponding to the detected data is made (S13). Subsequently, the notification control unit 123 determines the necessity of the second notification to the user U1. For example, whether or not the user U1 needs to have the second notification can be determined by whether or not the event is a predetermined event (for example, an event that should not be left unattended, or the like).

Subsequently, in a case where there is no need to make the second notification (“No” in S14), the notification control unit 123 finishes the operation. In contrast, in a case where the second notification is necessary (“Yes” in S14), the notification control unit 123 shifts the operation to S15. In a case where next operation by the user U1 is not detected (“No” in S15), the notification control unit 123 shifts the operation to S15. In contrast, in a case where the next operation by the user U1 is detected (“Yes” in S15), the notification control unit 123 controls the notification object 20 to make a second notification (S16), and finishes the operation.

The operation example of the information processing system according to the present embodiment has been described above.

### 1.3.8. Another Example of Position Control of Notification Object

The above example has described that, in a case where the importance level is lower than the first threshold and the urgency level is higher than the second threshold, the notification control unit 123 first positions the notification object 20 in the peripheral field of view R3, and then controls the notification object 20 to be or not to be positioned in one of the central field of view R1 or the effective field of view R2 of the user U1 in accordance with whether or not the state of the user U1 is a predetermined state. However, position control of the notification object 20 in the case where the importance level is lower than the first threshold and the urgency level is higher than the second threshold is not limited to such an example.

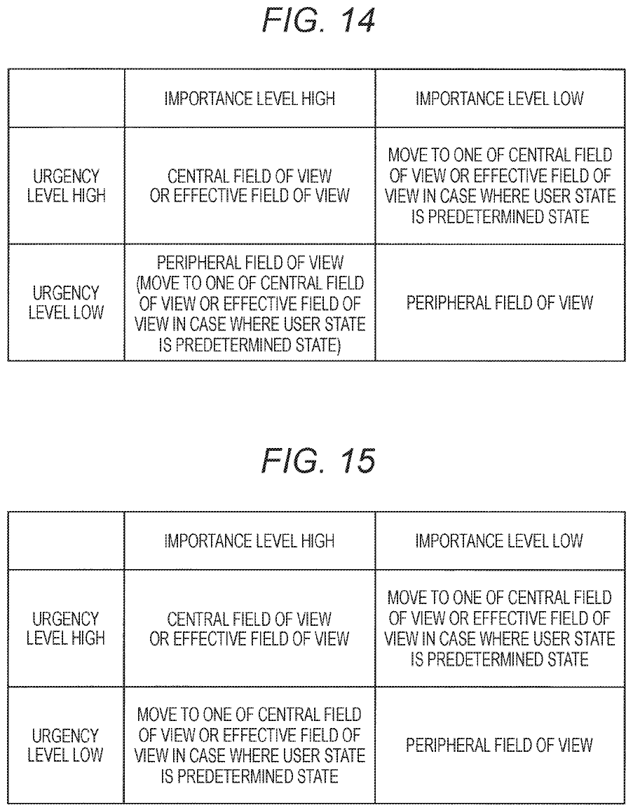

FIG. 14 is a diagram summarizing another correspondence between the importance level and the urgency level and the position of the notification object 20. As illustrated in FIG. 14, even in a case where the importance level is lower than the first threshold and the urgency level is higher than the second threshold, the notification control unit 123 would not need to position the notification object 20 in the peripheral field of view R3. Subsequently, the notification control unit 123 may control the notification object 20 to be or not to be positioned in the central field of view R1 or the effective field of view R2 of the user U1 in accordance with whether or not the state of the user U1 is a predetermined state.

Furthermore, the above example has described that, in a case where the importance level is higher than the first threshold and the urgency level is lower than the second threshold, the notification control unit 123 first positions the notification object 20 in the peripheral field of view R3, and then controls the notification object 20 to be or not to be positioned in one of the central field of view R1 or the effective field of view R2 of the user U1 depending on whether or not the state of the user U1 is a predetermined state. However, position control of the notification object 20 in the case where the importance level is higher than the first threshold and the urgency level is lower than the second threshold is not limited to such an example.

FIG. 15 is a diagram summarizing another correspondence between the importance level and the urgency level and the position of the notification object 20. As illustrated in FIG. 15, even in a case where the importance level is higher than the first threshold and the urgency level is lower than the second threshold, the notification control unit 123 would not need to position the notification object 20 in the peripheral field of view R3. Subsequently, the notification control unit 123 may control the notification object 20 to be or not to be positioned in the central field of view R1 or the effective field of view R2 of the user U1 in accordance with whether or not the state of the user U1 is a predetermined state.

### 2. HARDWARE CONFIGURATION EXAMPLE

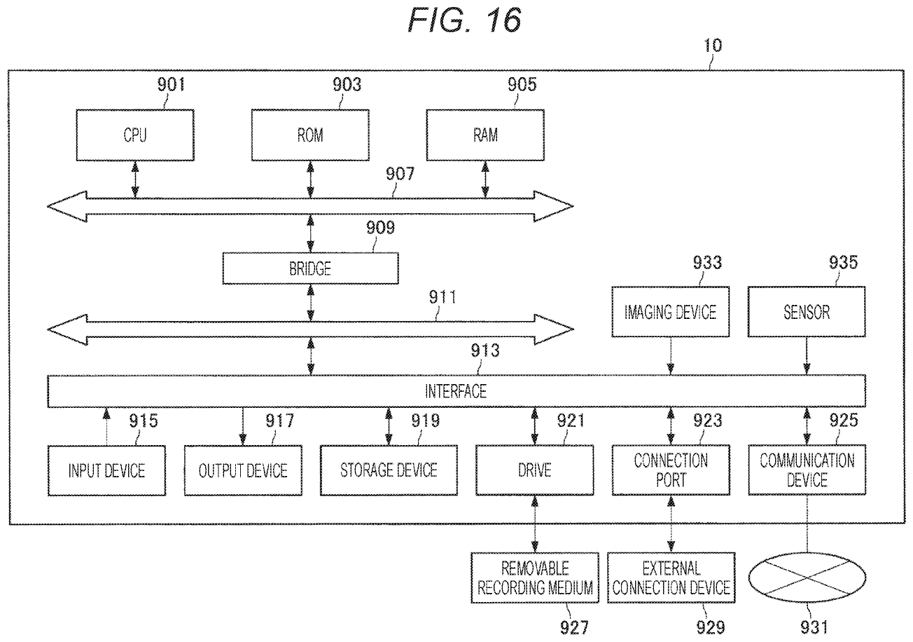

Next, a hardware configuration example of the information processing apparatus (agent) 10 according to the embodiment of the present disclosure will be described with reference to FIG. 16. FIG. 16 is a block diagram illustrating a hardware configuration example of the information processing apparatus 10 according to an embodiment of the present disclosure.

As illustrated in FIG. 16, the information processing apparatus 10 includes a central processing unit (CPU) 901, a read only memory (ROM) 903, and a random access memory (RAM) 905. Furthermore, the information processing apparatus 10 may include a host bus 907, a bridge 909, an external bus 911, an interface 913, an input device 915, an output device 917, a storage device 919, a drive 921, a connection port 923, and a communication device 925. Furthermore, the information processing apparatus 10 may include an imaging device 933 and a sensor 935 as needed. Instead of or in addition to the CPU 901, the information processing apparatus 10 may include a processing circuit referred to as a digital signal processor (DSP) or an application specific integrated circuit (ASIC).

The CPU 901 functions as an arithmetic processing unit and a control device, and controls the overall or part of operation in the information processing apparatus 10 in accordance with various programs recorded in the ROM 903, the RAM 905, the storage device 919, or the removable recording medium 927. The ROM 903 stores programs, calculation parameters, or the like, used by the CPU 901. The RAM 905 temporarily stores programs to be used in the execution by the CPU 901 or parameters that appropriately changes in execution of the programs, or the like. The CPU 901, the ROM 903, and the RAM 905 are mutually connected by a host bus 907 configured with an internal bus including a CPU bus or the like. Furthermore, the host bus 907 is connected to the external bus 911 such as a peripheral component interconnect/interface (PCI) bus via the bridge 909.

The input device 915 is a device that is operated by the user, such as a mouse, a keyboard, a touch panel, buttons, a switch, and a lever, for example. The input device 915 may include a microphone that detects user's voice. For example, the input device 915 may be a remote control device using infrared or other radio waves, or may be an external connection device 929 such as a mobile phone corresponding to the operation of the information processing apparatus 10. The input device 915 includes an input control circuit that generates an input signal on the basis of information input by the user and that outputs the generated input signal to the CPU 901. The user operates the input device 915, thereby inputting various types of data to the information processing apparatus 10 or giving an instruction on processing operation to the information processing apparatus 10. Furthermore, the imaging device 933, which will be described later, can also function as an input device by imaging the motion of the hand of the user, the finger of the user, or the like. At this time, the pointing position may be determined in accordance with the motion of the hand or the direction of the finger.

The output device 917 is configured with a device that can visually or audibly notify the user of acquired information. For example, the output device 917 can be a display device such as a liquid crystal display (LCD), a plasma display panel (PDP), an organic electro-luminescence (EL) display, a projector, a hologram display device, an audio output device such as a speaker and a headphone, and printer device, or the like. The output device 917 outputs a result acquired by the processing of the information processing apparatus 10 as a picture such as text or image, or outputs the same as sound such as voice or acoustic. Furthermore, the output device 917 may include a light for illuminating the surroundings, and the like.

The storage device 919 is a data storage device configured as an example of a storage unit of the information processing apparatus 10. For example, the storage device 919 includes a magnetic storage device such as a hard disk drive (HDD), a semiconductor storage device, an optical storage device, a magneto-optical storage device, or the like. The storage device 919 stores programs executed by the CPU 901, various data, various types of data acquired from the outside, or the like.

The drive 921 is a reader/writer for a removable recording medium 927 such as a magnetic disk, an optical disk, a magneto-optical disk, a semiconductor memory, or the like, and is incorporated in or provided outside the information processing apparatus 10. The drive 921 reads out information recorded on the attached removable recording medium 927 and outputs the information to the RAM 905. Furthermore, the drive 921 writes a record into the attached removable recording medium 927.

The connection port 923 is a port for directly connecting the device to the information processing apparatus 10. The connection port 923 can be, for example, a universal serial bus (USB) port, an IEEE 1394 port, a small computer system interface (SCSI) port, or the like. Furthermore, the connection port 923 may be an RS-232C port, an optical audio terminal, an High-Definition Multimedia Interface (HDMI) (registered trademark) port, or the like. Connecting external connection device 929 to the connection port 923 enables various types of data to be exchanged between the information processing apparatus 10 and the external connection device 929.

The communication device 925 is, for example, a communication interface including communication devices and the like for connecting to a communication network 931. The communication device 925 can be, for example, a communication card, etc., for local area network (LAN), Bluetooth (registered trademark), or a wireless USB (WUSB). Furthermore, the communication device 925 may be a router for optical communication, a router for asymmetric digital subscriber line (ADSL), a modem for various communication, or the like. For example, the communication device 925 transmits and receives signals or the like using a predetermined protocol such as TCP/IP with the Internet and other communication devices. Furthermore, the communication network 931 connected to the communication device 925 is a wired or wireless network, and is implemented by the Internet, home LAN, infrared communication, radio wave communication, satellite communication, or the like, for example.

The imaging device 933 is a device that images a real space using various members such as an imaging element such as a charge coupled device (CCD) or a complementary metal oxide semiconductor (CMOS) and a lens for controlling imaging of a subject image to the imaging element, thereby generating a captured image. The imaging device 933 may capture a still image or may capture a moving image.

The sensor 935 is, for example, various sensors such as a distance measuring sensor, an acceleration sensor, a gyro sensor, a geomagnetic sensor, a light sensor, a sound sensor, or the like. The sensor 935 acquires information regarding the state of the information processing apparatus 10, such as the posture of the housing of the information processing apparatus 10, and acquires information regarding the surrounding environment of the information processing apparatus 10, such as brightness and noise around the information processing apparatus 10, for example. Furthermore, the sensor 935 may include a global positioning system (GPS) sensor that receives a GPS signal and measures the latitude, longitude, and altitude of the device.

### 3. CONCLUSION

As described above, according to the embodiment of the present disclosure, there is provided the information processing apparatus 10 including: the acquisition unit 122 that acquires detected data that includes at least one of an importance level or an urgency level of an event; and the notification control unit 123 that controls the notification object 20 that makes a notification in various ways depending on content of the detected data such that the notification object 20 notifies the user U1 of predetermined notification content, in which the notification control unit 123 controls the notification object 20 to be or not to be positioned in a central field of view or an effective field of view of the user U1 on the basis of the detected data. According to the present configuration, it is possible to control to notify the user U1 in a manner more desirable for the user U1 in a case where an event occurs.

Hereinabove, the preferred embodiments of the present disclosure have been described above with reference to the accompanying drawings, while the technical scope of the present disclosure is not limited to the above examples. A person skilled in the art in the technical field of the present disclosure may find it understandable to reach various alterations and modifications within the technical scope of the appended claims, and it should be understood that they will naturally come within the technical scope of the present disclosure.

For example, the above example has mainly described a case in which the change of the device to the predetermined state is detected as an event. Additionally, the above example has mainly described a case in which at least one of the importance level and the urgency level of an event is acquired as detected data. However, instead of the importance level of the event in the above, it is possible to use the importance level of communication performed between people, the excitement level of communication, the interest level of user U1 for communication, and the like.

Here, the communication may be face-to-face communication or may be communication via the Internet or the like. Furthermore, the importance level, excitement level, and interest level may be recognized by the recognition unit 121 on the basis of content of communication, or may be recognized on the basis of the frequency of communication (recognition may be such that the higher the frequency, the higher the importance level, excitement level and interest level), or may be recognized on the basis of the number of participants in the communication (recognition may be such that the greater the number of participants, the higher the importance level, the excitement level, and the interest level.)

For example, the notification control unit 123 may control the notification object 20 such that the user U1 is notified of notification content (or such that notification content of which the user U1 is notified changes) in a case where any of the importance level, the excitement level, and the interest level exceeds the threshold. For example, in a case where any of the importance level, excitement level, or the interest level exceeds the threshold, the notification control unit 123 may bring the notification object 20 closer to the user U1, or may increase the frequency at which the notification object 20 gazes at the user U1, or may increase the time during which the notification object 20 is gazing at the user U1, or may change the facial expression of the notification object 20.

Furthermore, the above has described an example in which the user U1 is notified of different notification content in accordance with the importance level and the urgency level of the event. Moreover, in the above description, the notification content may be a sound emitted by the notification object 20, and the sound emitted by the notification object 20 may be text interpretable by the user U1 read out aloud. At this time, the tone of the text to be read may be changed in accordance with the importance level and the urgency level.

Furthermore, the above has described that the notification content may be a facial expression of the notification object 20. At this time, the facial expression of the notification object 20 is not limited to the example described above. For example, the facial expression of the notification object 20 may be different depending on the culture of the area or the like in which the information processing system (or the agent 10) described above is used.

Furthermore, it is also possible to create a program for causing hardware such as CPU, ROM and RAM built in the computer to exhibit functions equivalent to those of the above-described control unit 120. Furthermore, a computer-readable recording medium that records the program can also be provided.

For example, as long as the operation of the information processing apparatus 10 described above is implemented, the position of each configuration is not particularly limited. Processing of individual units in the information processing apparatus 10 may be partially performed by a server device (not illustrated). As a specific example, a part or all of the blocks included in the control unit 120 in the information processing apparatus 10 may be present in a server device (not illustrated) or the like. For example, a part or all of the functions of the recognition unit 121 in the information processing apparatus 10 may be present in a server device (not illustrated) or the like.

In addition, the effects described in this specification are merely illustrative or exemplary, and are not limiting. That is, the technology according to the present disclosure can exhibit other effects obvious to those skilled in the art from the description of the present specification together with the above effects or in place of the above effects.

Note that the following configuration should also be within the technical scope of the present disclosure.

(1)

An information processing apparatus including:

an acquisition unit that acquires detected data that includes at least one of an importance level or an urgency level of an event; and

a notification control unit that controls a notification object that makes a notification in various ways depending on content of the detected data such that the notification object notifies a user of predetermined notification content,

in which the notification control unit controls the notification object to be or not to be positioned in a central field of view or an effective field of view of the user on the basis of the detected data.

(2)

The information processing apparatus according to (1),

in which the detected data includes the importance level, and

the notification control unit positions the notification object in the central field of view or the effective field of view in a case where the importance level is higher than a first threshold.

(3)

The information processing apparatus according to (2),

in which, in a case where the importance level is higher than the first threshold, the notification control unit controls the notification object to be or not to be positioned in the central field of view or the effective field of view in accordance with whether or not a state of the user is a predetermined state.

(4)

The information processing apparatus according to (3),

in which, in a case where the importance level is higher than the first threshold, the notification control unit positions the notification object in a peripheral field of view of the user, and controls the notification object to be or not to be moved from the peripheral field of view to the central field of view or the effective field of view in accordance with whether or not the state of the user is a predetermined state.

(5)

The information processing apparatus according to (2),

in which the notification control unit positions the notification object in the peripheral field of view in a case where the importance level is lower than the first threshold.

(6)

The information processing apparatus according to any one of (2) to (5),

in which the notification control unit makes the notification content different between the case where the importance level is higher than the first threshold and the case where the importance level is lower than the first threshold.

(7)

The information processing apparatus according to (1),

in which the detected data includes the urgency level, and

the notification control unit positions the notification object in the central field of view or the effective field of view in a case where the urgency level is higher than a second threshold.

(8)

The information processing apparatus according to (7),

in which, in a case where the urgency level is higher than the second threshold, the notification control unit controls the notification object to be or not to be positioned in the central field of view or the effective field of view in accordance with whether or not the state of the user is a predetermined state.

(9)

The information processing apparatus according to (8),

in which, in a case where the urgency level is higher than the second threshold, the notification control unit positions the notification object in a peripheral field of view of the user, and controls the notification object to be or not to be moved from the peripheral field of view to the central field of view or the effective field of view in accordance with whether or not the state of the user is a predetermined state.

(10)

The information processing apparatus according to (7),

in which the notification control unit positions the notification object in the peripheral field of view in a case where the urgency level is lower than the second threshold.

(11)

The information processing apparatus according to any one of (7) to (10),

in which the notification control unit makes the notification content different between the case where the urgency level is higher than the second threshold and the case where the urgency level is lower than the second threshold.

(12)

The information processing apparatus according to any one of (1) to (11),

in which the notification control unit controls the notification object such that the notification object does not notify the user of the notification content in a case where a status of the user is a predetermined status.

(13)

The information processing apparatus according to any one of (1) to (12),

in which, in a case where the event is a predetermined event, the notification control unit controls the notification object to notify the user of the notification content again at a stage where operation of the user is transited to next operation.

(14)

The information processing apparatus according to any one of (1) to (13),

in which the notification content includes at least one of a state of the notification object, a motion of the notification object, and a sound emitted by the notification object.

(15)

The information processing apparatus according to any one of (1) to (14),

in which the acquisition unit acquires the detected data from information received from a device.

(16)

The information processing apparatus according to any one of (1) to (14),

in which, in a case where an analysis result of detected sound data matches or is similar to registered information registered beforehand, the acquisition unit acquires the detected data associated with the registered information.

(17)

The information processing apparatus according to any one of (1) to (16),

in which the notification object includes a real object located in a real space.

(18)

The information processing apparatus according to any one of (1) to (16),

in which the notification object includes a virtual object located in a virtual space.

(19)

An information processing method including:

acquiring detected data that includes at least one of an importance level or an urgency level of an event; and

controlling a notification object that makes a notification in various ways depending on content of the detected data such that the notification object notifies a user of predetermined notification content,

the method further including controlling, by a processor, the notification object to be or not to be positioned in a central field of view or an effective field of view of the user on the basis of the detected data.

(20)

A program that enables a computer to function as an information processing apparatus including:

an acquisition unit that acquires detected data that includes at least one of an importance level or an urgency level of an event; and

a notification control unit that controls a notification object that makes a notification in various ways depending on content of the detected data such that the notification object notifies a user of predetermined notification content,

in which the notification control unit controls the notification object to be or not to be positioned in a central field of view or an effective field of view of the user on the basis of the detected data.

### REFERENCE SIGNS LIST

10 Information processing apparatus (agent)
110 Detection unit
111 Sound collection unit
112 Imaging unit
120 Control unit
121 Recognition unit
122 Acquisition unit
123 Notification control unit
130 Storage unit
140 Communication unit
150 Notification unit
151 Sound output unit
152 Display unit
20 Notification object

1. An information processing apparatus comprising:
an acquisition unit that acquires detected data that includes at least one of an importance level or an urgency level of an event; and
a notification control unit that controls a notification object that makes a notification in various ways depending on content of the detected data such that the notification object notifies a user of predetermined notification content,
wherein the notification control unit controls the notification object to be or not to be positioned in a central field of view or an effective field of view of the user on a basis of the detected data.

2. The information processing apparatus according to claim 1,
wherein the detected data includes the importance level, and
the notification control unit positions the notification object in the central field of view or the effective field of view in a case where the importance level is higher than a first threshold.

3. The information processing apparatus according to claim 2,
wherein, in a case where the importance level is higher than the first threshold, the notification control unit controls the notification object to be or not to be positioned in the central field of view or the effective field of view in accordance with whether or not a state of the user is a predetermined state.

4. The information processing apparatus according to claim 3,
wherein, in a case where the importance level is higher than the first threshold, the notification control unit positions the notification object in a peripheral field of view of the user, and controls the notification object to be or not to be moved from the peripheral field of view to the central field of view or the effective field of view in accordance with whether or not the state of the user is a predetermined state.

5. The information processing apparatus according to claim 2,
wherein the notification control unit positions the notification object in the peripheral field of view in a case where the importance level is lower than the first threshold.

6. The information processing apparatus according to claim 2,
wherein the notification control unit makes the notification content different between the case where the importance level is higher than the first threshold and a case where the importance level is lower than the first threshold.

7. The information processing apparatus according to claim 1,
wherein the detected data includes the urgency level, and
the notification control unit positions the notification object in the central field of view or the effective field of view in a case where the urgency level is higher than a second threshold.

8. The information processing apparatus according to claim 7,
wherein, in a case where the urgency level is higher than the second threshold, the notification control unit controls the notification object to be or not to be positioned in the central field of view or the effective field of view in accordance with whether or not the state of the user is a predetermined state.

9. The information processing apparatus according to claim 8,
wherein, in a case where the urgency level is higher than the second threshold, the notification control unit positions the notification object in a peripheral field of view of the user, and controls the notification object to be or not to be moved from the peripheral field of view to the central field of view or the effective field of view in accordance with whether or not the state of the user is a predetermined state.

10. The information processing apparatus according to claim 7,
wherein the notification control unit positions the notification object in the peripheral field of view in a case where the urgency level is lower than the second threshold.

11. The information processing apparatus according to claim 7,
wherein the notification control unit makes the notification content different between the case where the urgency level is higher than the second threshold and a case where the urgency level is lower than the second threshold.

12. The information processing apparatus according to claim 1,
wherein the notification control unit controls the notification object such that the notification object does not notify the user of the notification content in a case where a status of the user is a predetermined status.

13. The information processing apparatus according to claim 1,
wherein, in a case where the event is a predetermined event, the notification control unit controls the notification object to notify the user of the notification content again at a stage where operation of the user is transited to next operation.

14. The information processing apparatus according to claim 1,
wherein the notification content includes at least one of a state of the notification object, a motion of the notification object, and a sound emitted by the notification object.

15. The information processing apparatus according to claim 1,
wherein the acquisition unit acquires the detected data from information received from a device.

16. The information processing apparatus according to claim 1,
wherein, in a case where an analysis result of detected sound data matches or is similar to registered information registered beforehand, the acquisition unit acquires the detected data associated with the registered information.

17. The information processing apparatus according to claim 1,
wherein the notification object includes a real object located in a real space.

18. The information processing apparatus according to claim 1,
wherein the notification object includes a virtual object located in a virtual space.

19. An information processing method comprising:
acquiring detected data that includes at least one of an importance level or an urgency level of an event; and
controlling a notification object that makes a notification in various ways depending on content of the detected data such that the notification object notifies a user of predetermined notification content,
the method further comprising controlling, by a processor, the notification object to be or not to be positioned in a central field of view or an effective field of view of the user on a basis of the detected data.

20. A program that enables a computer
to function as an information processing apparatus including:
an acquisition unit that acquires detected data that includes at least one of an importance level or an urgency level of an event; and
a notification control unit that controls a notification object that makes a notification in various ways depending on content of the detected data such that the notification object notifies a user of predetermined notification content,
wherein the notification control unit controls the notification object to be or not to be positioned in a central field of view or an effective field of view of the user on a basis of the detected data.
